(19) United States
(12) Patent Application Publication
(10) Pub. No.: US 2011/0042389 A1
(43) Pub. Date: Feb. 24, 2011

(54) TUBE HEAD AND PRODUCTION METHOD

(75) Inventor: Dominique Hanot, Vouvry (CH)

Correspondence Address: NIXON & VANDERHYE, PC, 901 NORTH GLEBE ROAD, 11TH FLOOR, ARLINGTON, VA, 22203, US

(73) Assignee: AISAPACK HOLDINGS s.a., Vouvry (CH)

(21) Appl. No.: 12/866,414

(22) PCT Filed: Feb. 2, 2009
(86) PCT No.: PCT/IB2009/050419

§ 371 Date: Nov. 1, 2010

(30) Foreign Application Priority Data
Feb. 5, 2008 (IB) PCTIB2008 050416

(51) Int. Cl. B65D 35/00; B65D 81/32; B29C 33/44; B29D 1/00

(52) U.S. Cl. 220/601; 425/436 R; 264/318

(57) ABSTRACT

The invention relates to a tube end (2) made of plastic formed in a single piece and made by a moulding method; end comprising a first cylindrical wall (7) comprising a thread (8) on its outer surface and a second, smaller, cylindrical wall (9) placed inside the first cylindrical wall (7), the two cylindrical walls (7, 9) being coaxial, the inner face of the second cylindrical wall (9) comprising a discontinuous thread (10, 11) defined by a series of sectors (10) and interruptions (11).

The invention also relates to a device and a method for the manufacture of the tube end.

### FIELD OF THE INVENTION

The invention lies in the field of packaging. It relates more precisely to the packaging of two products designed to be mixed just before use.

### DESCRIPTION OF THE PRIOR ART

Assemblies are known that are formed of a first tube which comprises an opening with an inner thread and a second tube comprising a neck with an outer thread, the second tube being able to be assembled with the first tube by screwing, thereby making it possible to transfer the content of the second tube into the first tube. An example of an assembly as described above is disclosed in French patent application FR 2 685 301. This type of assembly is used in many fields, in particular for hair dyes or adhesives which are formed by mixing two components.

Patent application EP 1 221 419 consists in a tube with an inner thread but the geometry of which requires the use of a very complex mould in order to remove the part which comprises a central pin from the mould. This solution is technically difficult and costly in production.

Patent application WO 03/050003 describes a tube, the opening of which has longitudinal shapes, sorts of ribs, into which the second tube is screwed by force, the thread of the latter having to carve its impression in these ribs. This means that the material of the second tube must be markedly harder than the first tube.

Patent application EP 1 958 890 also proposes a tube, the opening of which comprises a ring of teeth which allow the second tube furnished with a thread to be screwed or snapped on.

Usually the production by moulding of an inner thread is awkward. Because of its geometry, it has undercuts which cannot be removed from the mould by a simple translation movement of the mould portion. There are several solutions, in particular:
The shape of the thread is removed from the mould by unscrewing, the part of the mould is operated in a combined rotary and translational movement, therefore in the direction of a screw having the same pitch as the thread.
The shape of the thread is removed from the mould thanks to a device called a withdrawable chuck.

These methods are relatively complex and difficult to apply. Furthermore, they do not allow the production of threads below a minimum diameter.

The objects disclosed in the aforementioned prior art also have other disadvantages. The transfer of the content of one tube into the other tube may be slowed down or partially hampered because of the presence of air pockets.

Furthermore, the method for manufacturing the tube ends of the prior art is relatively complex and costly.

Finally, handling the tubes during mixing is not easy, particularly during the start-of-screwing phase.

### SUMMARY OF THE INVENTION

A first objective of the invention consists in simplifying the method for producing the tube end.

A second objective of the invention is to make it easier to handle the two tubes when mixing the contents.

A third objective consists in improving the transfer of the content from one tube into the other tube.

These objectives are achieved with the tube end according to the invention. The latter is formed in a single piece and made by a moulding method. The end comprises a first cylindrical wall comprising a thread on its outer surface and a second, smaller, cylindrical wall placed inside the first cylindrical wall, the two cylindrical walls being coaxial, the inner face of the second cylindrical wall comprising a discontinuous thread defined by a series of sectors and interruptions.

The presence of the interruptions makes it possible to clear the air pocket that is in the space situated between the contents to be mixed.

The invention also relates to an assembly formed of a tube end as previously described on to which another tube end is screwed.

Finally the invention relates to a method for producing a tube end which comprises a step of removing the inner thread from the mould which is achieved by pulling out.

One of the advantages provided by the invention is that it is possible to produce a tube shoulder geometry in a single operation, that is an operation that cannot be achieved with the tubes of the prior art, the latter being made up of two separate parts, the inner thread being on one part clipped into the opening, the vents being made in the clip.

### DETAILED DESCRIPTION OF THE INVENTION

The invention will be better understood below through the description of an embodiment of the latter and of the figures relating thereto, wherein:

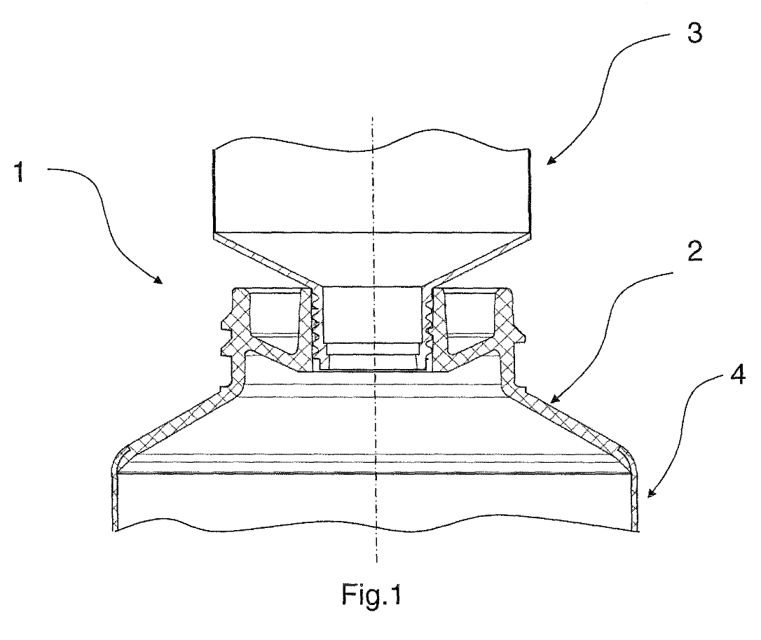

FIG. 1 represents a tube end according to the invention associated with another tube end.

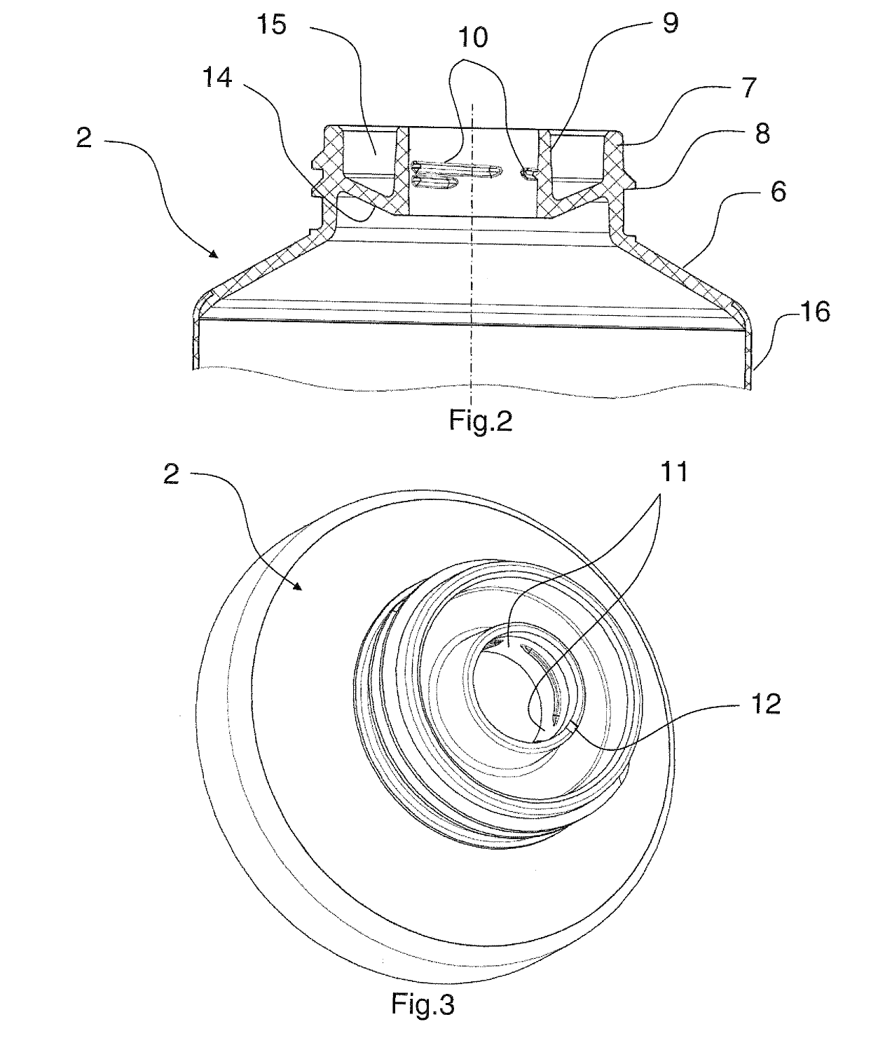

FIG. 2 represents a view in section of a tube end according to the invention as illustrated in FIG. 1.

FIG. 3 represents a view in perspective of the tube end according to the invention as illustrated in FIG. 1.

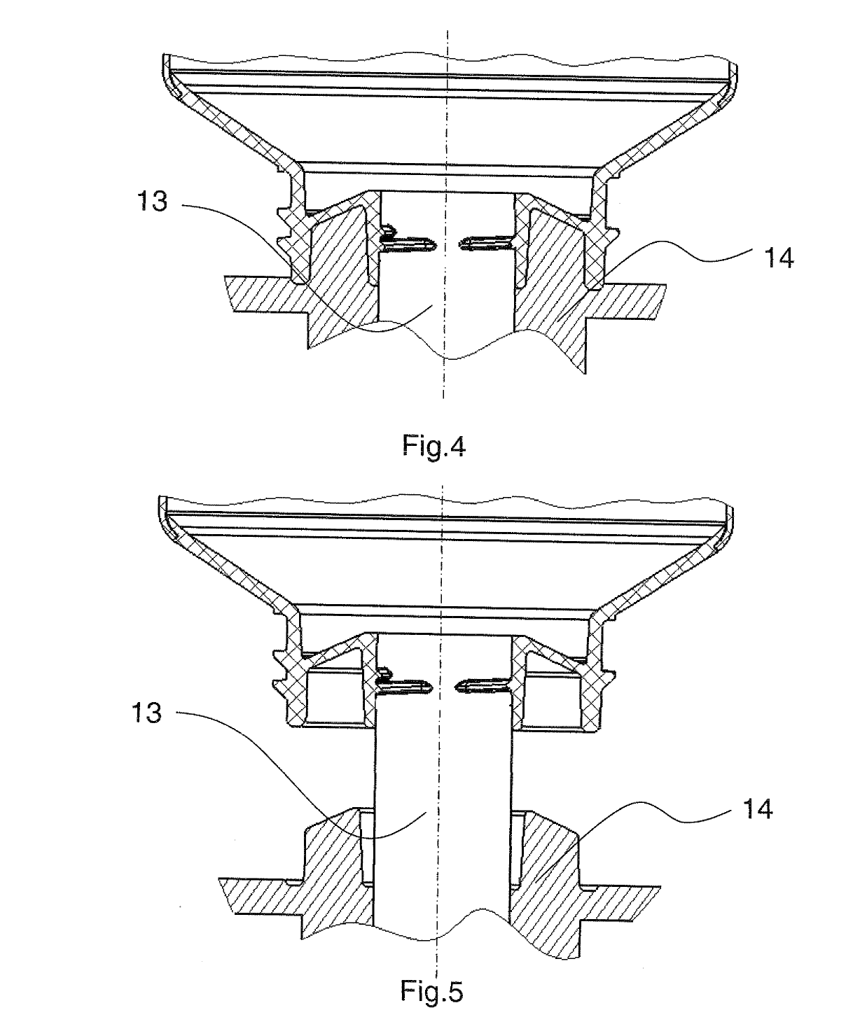

FIGS. 4, 5 and 6 represent the various steps of removing the thread of the tube end according to the invention from the mould as illustrated in the preceding figures.

The tube end 2 illustrated in FIG. 1 forms an element of a first tube 4, itself being associated with a second tube 3, the whole forming a packaging assembly 1. After opening, the second tube 3 is assembled by being screwed into the opening of the tube end 2, then the content of the tube 3 is transferred into the tube 4, partially filled, so as to mix the two products just before use. The first tube 4 is made of plastic, the second tube 3 may also be made of plastic but also of another material, for example of aluminium.

FIGS. 2 and 3 show the tube 4 made of plastic formed of a flexible cylindrical body 16, connected to an end 2 made by a moulding method. A shoulder 6 provides the connection between the body 16 and a first cylindrical wall 7 comprising a thread 8 on its outer surface. This outer thread 8 is used for closing the tube 4 with a screw cap not shown. A second, smaller, cylindrical wall 9, inside the first cylindrical wall 7, defines the opening of the tube 4. On the inner face of the cylindrical wall 9, there is a discontinuous thread 10, 11 defined by a series of sectors 10 and interruptions 11. This discontinuous thread 10,11 makes it possible to connect the second tube 3 to the first tube 4. The interruptions 11 form passageways for clearing the air when the product of the tube 3 is transferred into the tube 4. In addition, a notch 12 at the end of the cylindrical wall 9 allows the air to escape if the tube 3 is screwed right down, that is to say when the tube 3 abuts the upper edge of the second cylindrical wall 9.

The second cylindrical wall 9 is connected, at its base, to the cylindrical wall 7 by an annular partition 14, the three surfaces delimiting a cavity 15 which, as will be seen below, plays an important role in the production method according to the invention.

### Production Method

The tube end 2 according to the invention is designed so that its industrial production is economical and achievable with ordinary production means, without special devices.

The end 2 of the tube 4 is obtained by moulding in one step. The geometry of the end is designed so that the inner thread is removed from the mould by pulling out. The parts of the mould are moved only in translation, which is a conventional movement in mould-actuation mechanisms, much simpler to apply than combined rotation/translation mechanisms as described in the prior art.

FIGS. 4, 5 and 6 illustrate the steps of removing the inner thread from the mould. Only the parts directly involved in this function are shown, the other portions of the mould are masked.

FIG. 4 shows the relative position of the parts before removal from the mould, more precisely the rod 13 the periphery of which comprises the surfaces that are a negative of the interrupted thread 10, and the tubular casing 14 delimited by the surfaces of the cavity 15.

FIG. 5 shows the first phase of removal from the mould, the tubular casing 14 has completed a translation so as to release the surfaces of the cavity 15.

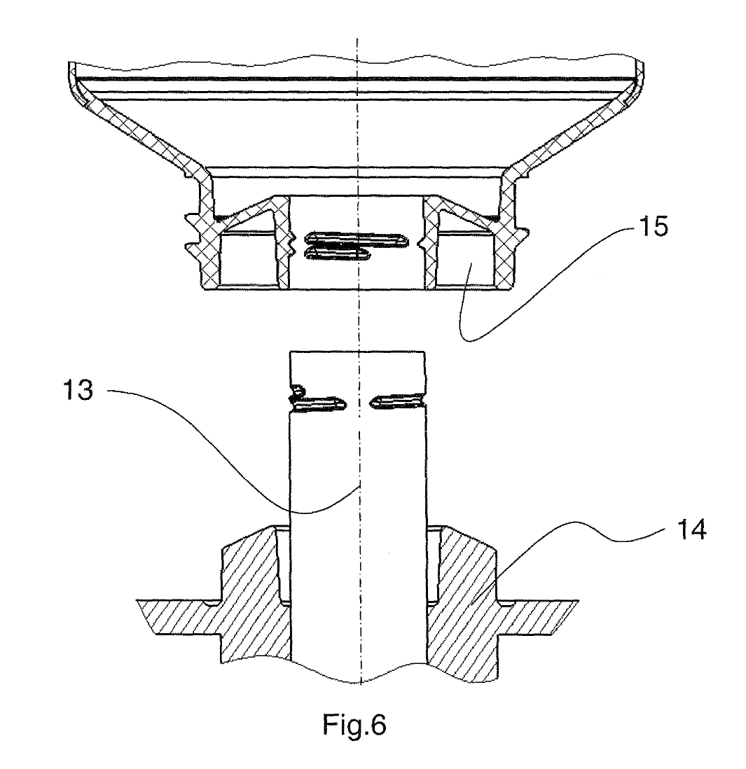

FIG. 6 shows the phase of removing the inner thread from the mould: the rod 13 has completed a translation so as to remove the inner thread 10 from the mould by pulling out. This operation is made easier by the fact that the outside of the cylindrical wall 9 is in the void of the cavity 15 and can deform temporarily in a concentric manner. The fact that the inner thread 10, 11 is made of several sectors 10 makes it easier to deform the cylindrical wall 9. The temporary concentric deformation of the cylindrical wall 9 makes it possible on the one hand to limit the traction force on the sectors 10 and on the other hand to minimize the deformation of the thread profile.

1. Tube end (2) made of plastic formed in a single piece and made by a moulding method; end comprising a first cylindrical wall (7) comprising a thread (8) on its outer surface and a second, smaller, cylindrical wall (9) placed inside the first cylindrical wall (7), the two cylindrical walls (7, 9) being coaxial, the inner face of the second cylindrical wall (9) comprising a discontinuous thread (10, 11) defined by a series of sectors (10) and interruptions (11).

2. Tube end (2) according to claim 1, wherein the upper edge of the first cylindrical wall (7) is situated in the same plane as the upper edge of the second cylindrical wall (9).

3. Tube end (2) according to claim 2, wherein the upper edge of the second cylindrical wall (9) comprises a notch (12).

4. Tube end (2) according to claim 1, wherein the bases of the two cylindrical walls (7, 9) are connected by an annular partition (14).

5. Assembly consisting of a tube end (2) according to claim 1 and another tube end (3), said other tube end (3) comprising a cylindrical wall furnished with a thread on its outer face, the said cylindrical wall and the said thread being adapted to be screwed inside the second cylindrical wall (9).

6. Device for producing a tube end (2) according to claim 1, comprising a rod (13) designed to be placed inside the second cylindrical wall (9), the said rod (13) being mounted so as to slide inside a tubular casing (14) and comprising on its outer face a relief as a negative of the inner thread (10, 11) of the second cylindrical wall (9).

7. Method for producing a tube end (2) by means of a device as defined in claim 6, the said method comprising only one step of moulding a tube end (2), and at least one step of removing the inner thread (10, 11) of the tube end (2) from the mould.

8. Method according to claim 7, wherein the said step of removing the inner thread from the mould is achieved by pulling out and temporary deformation of the second cylindrical wall (9).

9. Method according to claim 8, comprising a first step of removal from the mould during which the tubular casing (14) is moved in translation, the said first step being followed by the said pulling-out step.
